(19) United States
(12) Patent Application Publication
(10) Pub. No.: US 2025/0141759 A1
(43) Pub. Date: May 1, 2025

(54) METHOD AND APPARATUS FOR SPLITTING DOWNLINK DATA IN A DUAL/MULTI CONNECTIVITY SYSTEM

(71) Applicant: NOKIA SOLUTIONS AND NETWORKS OY, Espoo (FI)

(72) Inventors: Thomas TOURNAIRE, Boulogne-Billancourt (FR); Fahad SYED MUHAMMAD, Orsay (FR); Afef FEKI, Sceaux (FR); Lorenzo MAGGI, Paris (FR); Francois DURAND, Clichy (FR)

(21) Appl. No.: 18/728,655

(22) PCT Filed: Jan. 17, 2023
(86) PCT No.: PCT/EP2023/050953

§ 371 Date: Jul. 12, 2024

(30) Foreign Application Priority Data
Jan. 25, 2022 (FI) 20225055

(51) Int. Cl. H04L 41/16; H04W 24/02

(52) U.S. Cl. CPC H04L 41/16; H04W 24/02

(57) ABSTRACT

A first base station and a central entity for use in a radio access network implementing a dual/multiconnectivity scheme where the first base station is caused to split downlink data associated with a plurality of user devices between a first path through the first base station and a second path through the at least one second base station. The splitting comprises a plurality of reinforcement learning agents associated with the plurality of user devices. The reinforcement learning agents apply a current common neural network policy to select a path amongst the first and the second paths based on observed performance metrics of the first and second paths and to generate a reward associated with the selected path and send their experiences to the central entity. The central entity updates the common neural network policy based on the received experiences. The central unit can be implemented in a RIC.

### TECHNICAL FIELD

Various example embodiments relate generally to methods and apparatus for splitting downlink data associated with a plurality of user devices between a first path through a first base station and at least one second path through at least one second base station in a radio access network.

In particular, they apply to a Radio Access Network (RAN) of a mobile communication system, for example a 5G (fifth generation) system using the 5G NR (New Radio) as radio access technology (RAT) defined by 3GPP.

### BACKGROUND

5G NR has introduced the concept of Dual connectivity/Multi connectivity to enable a 4G and a 5G connection to occur at the same time in the radio access network. This technology provides improved network coverage and bandwidth.

5G Dual connectivity/Multi connectivity radio access systems comprise a first and at least one second base stations to convey downlink data to a user device. The first base station (also referred to as master node) is connected to the core network and is responsible for splitting the downlink data received at the first base station between a first and at least one second paths (also referred to as legs), the first path conveying data over the air through a F1 interface to the user device and the second path conveying data over a X2-U interface to the second base station (also referred to as secondary node). The splitting operation is done at the Packet Data Convergence Protocol (PDCP) layer of the first base station. A PDCP splitting function at the first base station decides whether a PDCP Packet Data Unit (PDU) shall be forwarded to the user device directly via the first path, or through the second base station via the second path.

Currently implemented splitting solutions consist of estimating delays experienced over the different paths and redirect the incoming packets toward the path with the shortest delay. For example delay estimation can be obtained using analytical methods such as Little's Law, or supervised learning based solutions.

Known splitting solutions are only reactive since a path is avoided only after measuring a high delay associated with it. They don't consider whether a path may get congested soon. Once the congestion is detected it is already too late to avert it. Therefore known solutions are congestion proned.

There is a need for a proactive splitting solution which not only directs packets towards the path offering the shortest delay but also is far-sighted enough to not cause congestion in the overall system.

### SUMMARY

The scope of protection is set out by the independent claims. The embodiments, examples and features, if any, described in this specification that do not fall under the scope of the protection are to be interpreted as examples useful for understanding the various embodiments or examples that fall under the scope of protection.

According to a first aspect, a first base station is disclosed, for use in a radio access network comprising at least one second base station, the first base station comprising splitting means for splitting downlink data associated with a plurality of user devices between a first path through the first base station and at least one second path through the at least one second base station, the splitting means comprising a plurality of reinforcement learning agents associated with the plurality of user devices, wherein the reinforcement learning agents comprise means for:
applying a current common neural network policy to select a path amongst the first and the second paths based on observed performance metrics of the first and second paths and to generate a reward associated with the selected path,
sending tuples comprising the selected path, the performance metric associated with the selected path and the reward associated with the selected path, to a central entity in the radio access network,
receiving an updated common neural policy from the central entity, and
updating the current common neural network policy with the updated common neural network policy.

According to a second aspect, a device is disclosed comprising a central entity for providing a common neural network policy to a first base station for splitting downlink data associated with a plurality of user devices between a first path through the first base station and at least one second path through at least one second base station in a radio access network, the central entity comprising means for:
receiving tuples from reinforcement learning agents in the first base station, the reinforcement learning agents being associated with the plurality of user devices, the reinforcement learning agents applying the current common neural network policy to select a path amongst the first and the second paths based on observed performance metrics of the first and second paths and to generate a reward associated with the selected path, a given tuple comprising a given selected path, a given performance metric associated with the given selected path and a given reward associated with the given selected path,
generating an updated common neural network policy by maximizing an expected cumulative reward for the received tuples,
sending the updated common neural network policy to the reinforcement learning agents of the first base station.

According to a third aspect, a method is disclosed for splitting downlink data associated with a plurality of user devices between a first path through a first base station and at least one second path through at least one second base station in a radio access network, the method comprising using a plurality of reinforcement learning agents associated with the plurality of user devices, the reinforcement learning agents:
applying a current common neural network policy to select a path amongst the first and second paths based on observed performance metrics of the first and second paths and to generate a reward associated with the selected path,
sending tuples comprising the selected path, the performance metric associated with the selected path and the reward associated with the selected path, to a central entity in the radio access network,
receiving an updated common neural policy from the central entity,
updating the current common neural network policy with the updated common neural network policy.

According to a fourth aspect, a method is disclosed for providing a common neural network policy for splitting downlink data associated with a plurality of user devices between a first path through a first base station and at least one second path through at least one second base station in a radio access network, the method comprising:
receiving tuples from reinforcement learning agents in the first base station, the reinforcement learning agents being associated with the plurality of user devices, at least one of the reinforcement learning agent applying the current common neural network policy to select a path amongst the first and second paths based on observed performance metrics of the first and second paths and to generate a reward associated with the selected path, a given tuple comprising a given selected path, a given performance metric associated with the given selected path and a given reward associated with the given selected path,
generating an updated common neural network policy by maximizing an expected cumulative reward for the received tuples,
sending the updated common neural network policy to the reinforcement learning agents of the first base station.

According to another aspect, a computer program product is disclosed, comprising a set of instructions which, when executed on an apparatus, cause the apparatus to carry out a method for splitting downlink data associated with a plurality of user devices between a first path through a first base station and at least one second path through at least one second base station in a radio access network, the method comprising using a plurality of reinforcement learning agents associated with the plurality of user devices, the reinforcement learning agents:
applying a current common neural network policy to select a path amongst the first and second paths based on observed performance metrics of the first and second paths and to generate a reward associated with the selected path,
sending tuples comprising the selected path, the performance metric associated with the selected path and the reward associated with the selected path, to a central entity in the radio access network,
receiving an updated common neural policy from the central entity,
updating the current common neural network policy with the updated common neural network policy.

According to another aspect, a computer program product is disclosed, comprising a set of instructions which, when executed on an apparatus, cause the apparatus to carry out a method for providing a common neural network policy for splitting downlink data associated with a plurality of user devices between a first path through a first base station and at least one second path through at least one second base station in a radio access network, the method comprising:
receiving tuples from reinforcement learning agents in the first base station, the reinforcing learning agents being associated with the plurality of user devices, the reinforcement learning agents applying the current common neural network policy to select a path amongst the first and second paths based on observed performance metrics of the first and second paths and to generate a reward associated with the selected path, a given tuple comprising a given selected path, a given performance metric associated with the given selected path and a given reward associated with the given selected path,
generating an updated common neural network policy by maximizing an expected cumulative reward for the received tuples,
sending the updated common neural network policy to the reinforcement learning agents of the first base station.

According to another aspect the disclosed computer program product is embodied as a computer readable medium or directly loadable into a computer.

According to another aspect, a first base station is disclosed, for use in a radio access network comprising at least one second base station, the first base station comprising at least one processor and at least one memory including computer program code, the at least one memory and the computer program code being configured to, with the at least one processor, cause the first base station to split downlink data associated with a plurality of user devices between a first path through the first base station and at least one second path through the at least one second base station, including implementing a plurality of reinforcement learning agents associated with the plurality of user devices, wherein the reinforcement learning agents are configured to:
apply a current common neural network policy to select a path amongst the first and the second paths based on observed performance metrics of the first and second paths and to generate a reward associated with the selected path,
send tuples comprising the selected path, the performance metric associated with the selected path and the reward associated with the selected path, to a central entity in the radio access network,
receive an updated common neural policy from the central entity.

According to another aspect, a device is disclosed comprising at least one processor and at least one memory including computer program code, the at least one memory and the computer program code being configured to, with the at least one processor, cause the device to provide a common neural network policy to a first base station for splitting downlink data associated with a plurality of user devices between a first path through the first base station and at least one second path through at least one second base station in a radio access network, including:
receive tuples from reinforcement learning agents in the first base station, the reinforcement learning agents being associated with the plurality of user devices, the reinforcement learning agents applying the current common neural network policy to select a path amongst the first and the second paths based on observed performance metrics of the first and second paths and to generate a reward associated with the selected path, a given tuple comprising a given selected path, a given performance metric associated with the given selected path and a given reward associated with the given selected path,
generate an updated common neural network policy by maximizing an expected cumulative reward for the received tuples,
send the updated common neural network policy to the reinforcement learning agents of the first base station.

According to a first embodiment, the common neural network policy is initialized with an initial policy.

According to a second embodiment, the initial policy is generated offline, based on labelled data, and is optimized to select the path currently offering the best performance metric.

According to a third embodiment, the initial policy is obtained from the central entity as the result of a training phase during which at least one reinforcement learning agent applies the current common neural network policy sent by the central entity and the other reinforcement learning agents select the path currently offering the best performance metric instead of applying the current common neural network policy sent by the central entity.

All but at least one reinforcement learning agents comprise means for selecting the path currently offering the best performance metric, instead of applying the current common neural network policy sent by the central entity, during a training phase used to obtain the initial policy from the central entity.

According to a fourth embodiment, maximizing an expected cumulative reward for the received tuples is achieved by using a policy gradient method. For example, the policy gradient method is a Proximal Policy Optimization algorithm.

According to fifth embodiment, the performance metric is the amount of data in flight over the first and second paths.

Generally, the means referred to above in relation to the first base station include circuitry configured to perform one or more or all steps of the method for splitting downlink data associated with a plurality of user devices between a first path through a first base station and at least one second path through at least one second base station in a radio access network.

Generally, the means referred to above in relation to the central entity include circuitry configured to perform one or more or all steps of the method for providing a common neural network policy for splitting downlink data associated with a plurality of user devices between a first path through a first base station and at least one second path through at least one second base station in a radio access network.

The means may include at least one processor and at least one memory including computer program code, wherein the at least one memory and the computer program code are configured to, with the at least one processor, cause the apparatus to perform one or more or all steps of the method disclosed herein.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 is a schematic representation of a RAN implementing a dual connectivity scheme.

FIG. 2 is a schematic representation of a reinforcement learning agent as known in the prior art.

FIG. 3 is a block diagram of an example embodiment of a system for implementing a splitting function as disclosed herein.

FIG. 4 is a flow chart of an example embodiment of a method for splitting downlink data as disclosed herein.

FIG. 5 is a schematic diagram of an example implementation in a RAN of a system for implementing a splitting function as disclosed herein.

FIG. 6 is a schematic diagram of an example embodiment of an apparatus suitable for implementing a first base station and a device hosting a central entity as disclosed herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing example embodiments. The example embodiments may, however, be embodied in many alternate forms and should not be construed as limited to only the embodiments set forth herein. Accordingly, while example embodiments are capable of various modifications and alternative forms, the embodiments are shown by way of example in the drawings and will be described herein in detail. It should be understood, however, that there is no intent to limit example embodiments to the particular forms disclosed.

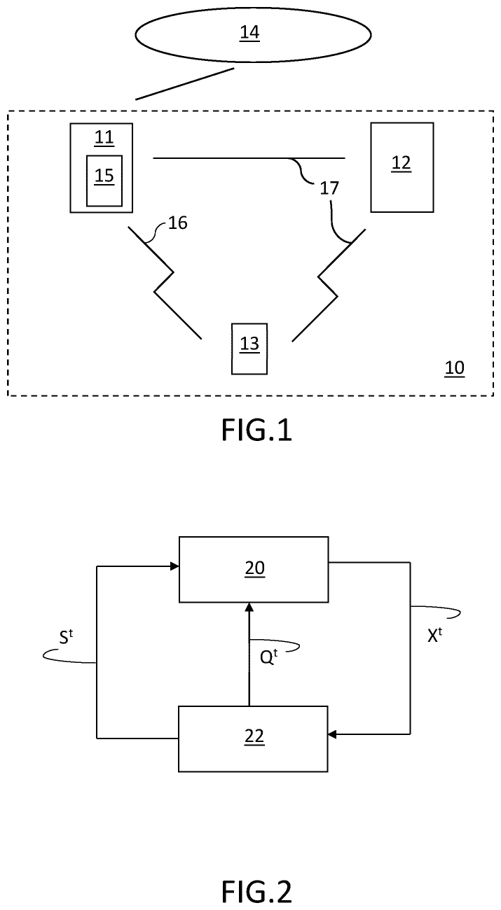

FIG. 1 shows a schematic representation of an example of a RAN 10 implementing a dual connectivity scheme in which the methods described herein may be applied. The RAN 10 comprises a first base station 11, a second base station 12 and a user device 13. The first base station 11 is connected to a core network 14 and comprises splitting means 15 for splitting downlink data associated with the user device 13, received at the first base station 11 from the core network 14, between a first path 16 and a second path 17 associated with the user device 13. The first path 16 conveys the data over the air to the user device 13 directly. The second path 17 conveys the data to the user device 13 through the second base station 12.

In an embodiment, the first base station is a 4G node (commonly referred to as MeNB) and the second base station is a 5G node (commonly referred to as gNB). The first base station 11 communicates with the core network 14 through a S1-MME interface. The first base station 11 communicates with the second base station 12 through a X2 interface. The first base station 11 serves the user device 13 through a F1 interface via a 4G radio link and the second base station 12 serves the user device 13 through a F1 interface via a 5G radio link.

In a multi-connectivity scheme, a plurality of second paths 17 is available and the splitting means 15 are designed to split the downlink data associated with a user device 13 between the first path 16 and the plurality of second paths 17.

For simplicity, only one user device is represented in FIG. 1. However the RAN 10 typically comprises a plurality M of user devices.

In the following of the description the total number of paths amongst which downlink data are to be split for a user UEₘ (m=1, . . . , M) is denoted Pₘ with Pₘ≥2.

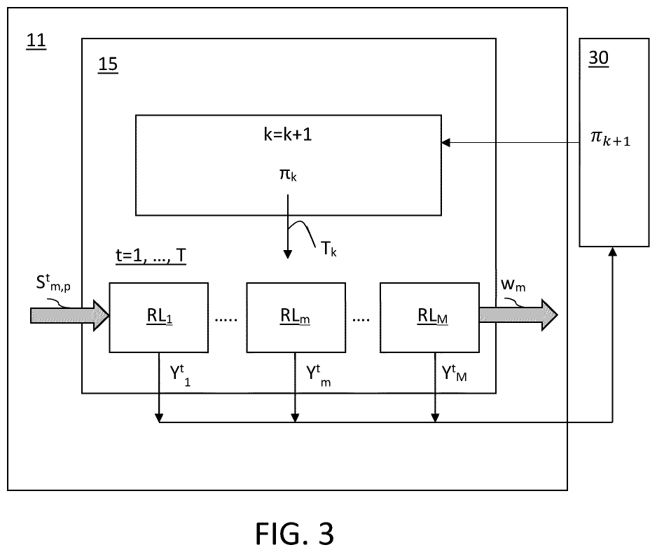

As will be described further below by reference to FIG. 3 the splitting means 15 in the first base station 11 comprise a plurality M of reinforcement learning agents RL₁, . . . , RLₘ, . . . RL_{M} associated with the plurality M of user devices UE₁, . . . UEₘ, . . . UE_{M}. FIG. 2 is a schematic diagram of a reinforcement learning agent as known in the prior art. As described in FIG. 2, a reinforcement learning agent 20 interacts with an environment 22. The reinforcement learning agent 20 receives as input observations S^{t} relating to a current state of the environment 22 at time t and makes a decision relating to an action X^{t} to be relayed to the environment 22. The decision is made by applying a neural network policy to the observations S^{t}. Once the action X^{t} has been applied to the environment 22 a reward Q^{t} is generated which indicates whether the action taken X^{t} had a positive or a negative impact on the environment 22. The reward Q^{t} is then used by the reinforcement learning agent 20 to update the neural network policy.

In the context of this disclosure, the reinforcement learning agents RLₘ (m=1, . . . , M) receive performance metrics associated with the Pₘ available paths as observations of the environment. Based on the received performance metrics, they generate a probability that a path is used for conveying the downlink data. The path wₘ of highest probability amongst the Pₘ paths is selected to convey the downlink data to the user devices UEₘ.

In an embodiment, the performance metrics are based on the amount of data in flight over the Pₘ paths. In an alternative embodiment the performance metrics are based on the throughput over the Pₘ paths. Other performance metrics linked with the radio conditions may be used as alternatives or in combination.

The operation of the reinforcement learning agents RL₁, . . . , RLₘ, . . . RL_{M} according to the present disclosure will now be described in relation to FIG. 3. As illustrated in FIG. 3, the plurality M of reinforcement learning agents RL₁, . . . , RLₘ, . . . RL_{M} in the splitting means 15 apply a neural network policy πₖ of parameters θₖ, common to all reinforcement learning agents RLₘ (m=1, . . . , M) to select a path wₘ amongst the Pₘ paths available at the first base station 11. The neural network policy used by all the reinforcement learning agents RL₁, . . . , RLₘ, . . . RL_{M} is referred to as common neural network policy in the following of the description and is denoted πₖ. The common neural network policy πₖ is generated at iteration k by a central entity 30 and is pushed to the M reinforcement learning agents RLₘ at time Tₖ.

Iteration k comprises at least one episode t (t=1, . . . , T) during which the reinforcement learning agents RLₘ (m=1, . . . , M):
receive observed performance metrics S_{m,p}^{t} for the Pₘ available paths (p=1, . . . , Pₘ),
apply the current common neural network policy πₖ to generate the probability for a path to be used,
select the path wₘ of highest probability,
generate a reward Q_{w}_{ₘ}^{t} associated with the selected path wₘ, and
send a tuple Y^{t}₁, . . . , Y^{t}ₘ, . . . Y^{t}_{M} representing their experience for episode t to the central entity 30.

For example, tuple Y^{t}ₘ is generated by the reinforcement learning agent RLₘ during episode t and comprises the selected path wₘ, the performance metrics S_{m,w}_{ₘ}^{t} associated with the selected path wₘ and the reward Q_{w}_{ₘ}^{t} associated with the selected path wₘ.

Upon reception of the tuples Y^{t}ₘ from the reinforcement learning agents RL₁, . . . , RLₘ, . . . RL_{M}, the central entity 30 generates an updated common neural network policy πₖ₊₁ of parameters θₖ₊₁. The updated common neural network policy πₖ₊₁ is generated by maximizing an expected cumulative reward for the tuples received from all reinforcement learning agents RL₁, . . . , RLₘ, . . . , RL_{M} over the T episodes (T≥1). Then the updated common neural network policy πₖ₊₁ is pushed to the reinforcement learning agents RL₁, . . . , RLₘ, . . . , RL_{M} for a next iteration with k=k+1.

In an embodiment the observed performance metrics S_{m,p}^{t} for episode h includes a history of data in flight β_{m,p}(t) for the path p over the last h episodes:

$${S}_{m , p}^{t} = {β}_{m , p} ( t ) , {β}_{m , p} ( t - 1 ) , … , {β}_{m , p} ( t - h - 1 )$$

In an embodiment, the observed performance metrics S_{m,p}^{t} are sent to the splitting means 15 in a DDDS message (Downlink Data Delivery Status).

In an embodiment, the reward Q^{t}ₚ associated with the action of selecting the path p at time t is calculated by the splitting means 15 by applying a function f which is a decreasing function of the data in flight βₚ(t) at time t. For example f(βₚ(t))=−βₚ(t)².

In an embodiment, the parameters θₖ₊₁ of the common neural network policy πₖ₊₁ are obtained by maximizing an expected discounted cumulative reward over the T episodes:

$${max}_{{π}_{k}} E [ {\sum }_{t = 0}^{T} {γ}^{t} f ( {β}_{p} ( t ) ) ]$$

where γ is a discount rate (typically set to 0.99) and E represents the expected value.

In an embodiment, the maximization is achieved by using a policy gradient method, for example a Proximal Policy Optimization (PPO) algorithm.

The PPO algorithm is well known and may be applied for determining the parameters θₖ₊₁ of a neural network policy πₖ₊₁ that optimize a loss [symbol] _{π}_{ₖ} function on a batch of tuples Y^{t}ₘ generated under policy πₖ over T episodes:

$${ℒ}_{{π}_{k}} ( {θ}_{k} ) = {E}_{{π}_{k}} [ {\sum }_{t = 0}^{T} [ min ( {r}_{t} ( {θ}_{k} ) * , clip ( {r}_{t} ( {θ}_{k} ) , 1 - ϵ , 1 + ϵ ) * ) ] ] \qquad ( 1 )$$

where rₜ(θₖ) is the ratio of the probability that action X^{t} is taken for state S^{t} under the current policy πₖ and under the previous policy πₖ₋₁

$${r}_{t} ( {θ}_{k} ) = \frac{{π}_{k} ( {X}^{t} \vert {S}^{t} )}{{π}_{k - 1} ( {X}^{t} \vert {S}^{t} )}$$

and [symbol] is the estimated advantage for policy πₖ computed as follows:

$$= {δ}_{t} + ( γλ ) {δ}_{t + 1} + … + {( γλ )}^{T - t + 1} {δ}_{T - 1}$$

$$with {δ}_{t} = f ( {β}_{{a}_{t}} ) + γ V ( {s}_{t + 1} ) - V ( {s}_{t} )$$

where λ is known as GAE (Generalized Advantage Estimator) factor (typically set to 0.95) and V is the neural network value function.

The second term in equation (1), {clip(rₜ(θₖ), 1−ϵ, 1+ϵ)* [symbol] }, modifies the loss function such the new policy πₖ₊₁ is not too far from previous policy πₖ.

Optimisation is done through stochastic gradient descend techniques such as ADAM optimiser.

In an embodiment, to accelerate convergence, the common neural network policy is initialized with an initial policy π₀.

In a first implementation the initial policy π₀ is generated off-line, based on labelled data and is optimized to select the path currently offering the best performance metric. For example the parameters θ₀ of the common neural network policy π₀ are initialized to replicate an expert policy such as JSQ (Join the Shortest Queue).

In a second implementation the initial policy π₀. is learned on-line with one reinforcement learning agent training the common neural network policy as described above while the other reinforcement learning agents apply an expert policy to select the path currently offering the best performance metric. In this second implementation, all but at least one reinforcement learning agents comprise means for selecting, during the training phase, the path currently offering the best performance metric (instead of applying the current common neural network policy sent by the central entity).

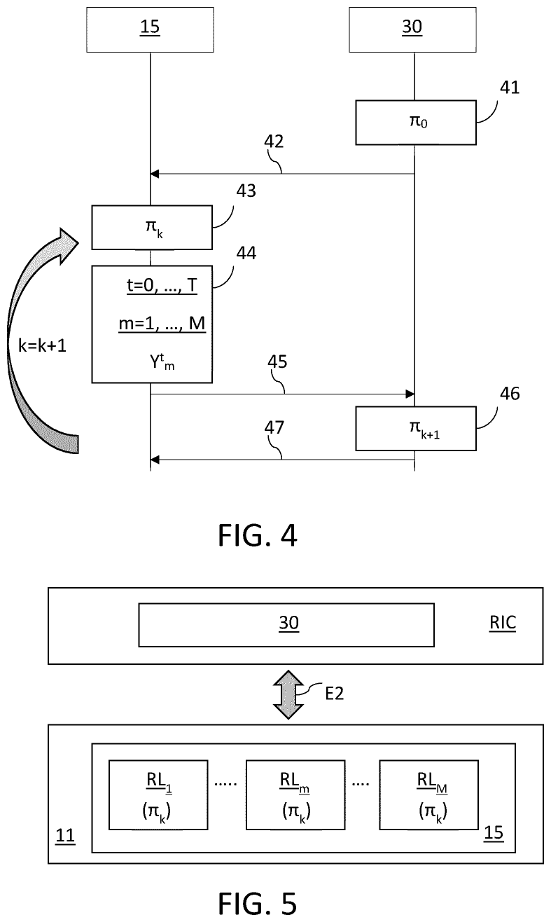

FIG. 4 illustrates the steps of the methods implemented by the splitting means 15 to split downlink data and by the central entity 30 to provide a common neural network policy πₖ to the splitting means 15. At step 41 the common neural network policy is initialized with policy π₀. At step 42, the initial common neural network policy π₀ is sent to the splitting means 15. At step 43, all reinforcement learning agents RL₁, . . . , RLₘ, . . . RL_{M} receives the updated common neural network policy πₖ. At step 44, one or more episodes t (t=1, . . . , T) take place during which the reinforcement learning agents RL₁, . . . , RLₘ, . . . RL_{M} implement the received policy πₖ to select amongst the Pₘ available paths, the paths wₘ to be used at time t to convey the downlink data to the user devices UEₘ. For each episode t, at step 45, a tuple Y^{t}ₘ is sent by each reinforcement learning agent RLₘ to the central entity 30. The tuple Y^{t}ₘ comprises the selected path wₘ, the performance metrics S_{m,w}_{ₘ}^{t} associated with the selected path wₘ and the reward Q_{w}_{ₘ}^{t} associated with the selected path wₘ. At step 46, the central entity 30 generates an updated common neural network policy πₖ₊₁ by maximizing an expected cumulative reward for the tuples received over the T episodes. At step 47, the updated common neural network policy πₖ₊₁ is sent to the splitting means 15. The process described in relation to steps 43 to 47 is then repeated with k=k+1.

FIG. 5 is a schematic representation of an implementation in a RAN of a system comprising a first base station 11 and a central entity 30 as disclosed above. As illustrated in FIG. 5 the splitting means 15 are implemented in the first base station 11 and comprise a plurality of reinforcement learning agents RL₁, . . . , RL_{M}. All reinforcement learning agents RL₁, . . . , RL_{M} are configured with the current common neural network policy πₖ. The central entity 30 is hosted in a RAN Intelligent Controller (RIC) in the RAN and the splitting means 15 communicate with the central entity through a E2 interface to send the experiences Y^{t}ₘ of the reinforcement learning agents of RL₁, . . . , RL_{M} to the central entity 30 and to receive the local version of the current common neural network policy πₖ to be applied by the reinforcement learning agents RL₁, . . . , RL_{M}.

While the steps are described in a sequential manner, the man skilled in the art will appreciate that some steps may be omitted, combined, performed in different order and/or in parallel. For example, the tuples Y^{t}ₘ can be sent to the central entity 30 after each episode or at the end of the T episodes.

In the embodiment of FIG. 5, the reinforcement learning agents are implemented in the first base station 11 to meet the real time requirements for the data split. But the resources available at the first base station are limited. Therefore it is advantageous to host the central entity 30 in the RIC which offers near-real time capabilities which are sufficient for updating (i.e., replacing or modifying) the common neural network policy. This implementation scheme is not limitative and the central entity 30 may be hosted anywhere in the RAN in a device that has an interface with the first base station 11 and provide near real time capabilities.

The disclosed method and apparatus use a centralized multi-agents reinforcement learning setting where reinforcement agents share a common neural network policy. The central entity 30 collects experiences from all reinforcement learning agents RLₘ to determine the common neural network policy. This allows the central entity to cover different radio conditions and congestions on different interfaces (F1 and X2 interfaces for instance in a LTE/5G environment) and to learn on a large set of experiences. The central entity minimizes the overall experienced delay in the long term. This allows to anticipate the possible occurrence of a congestion over any path, hence avoiding congestion in timely manner. It also allows to account for traffic seasonality. It also adapts to the reactive behavior of transmission protocols (for example TCP) which adapt traffic to the perceived quality of service which in turn depends on the action taken by the reinforcement learning agents.

In another embodiment of the present disclosure, not illustrated in the drawings, the same central entity is used for several first base stations that serve user devices located in neighboring cells. With such an implementation the common neural network policy is further enriched using experiences of user devices served by different first base stations.

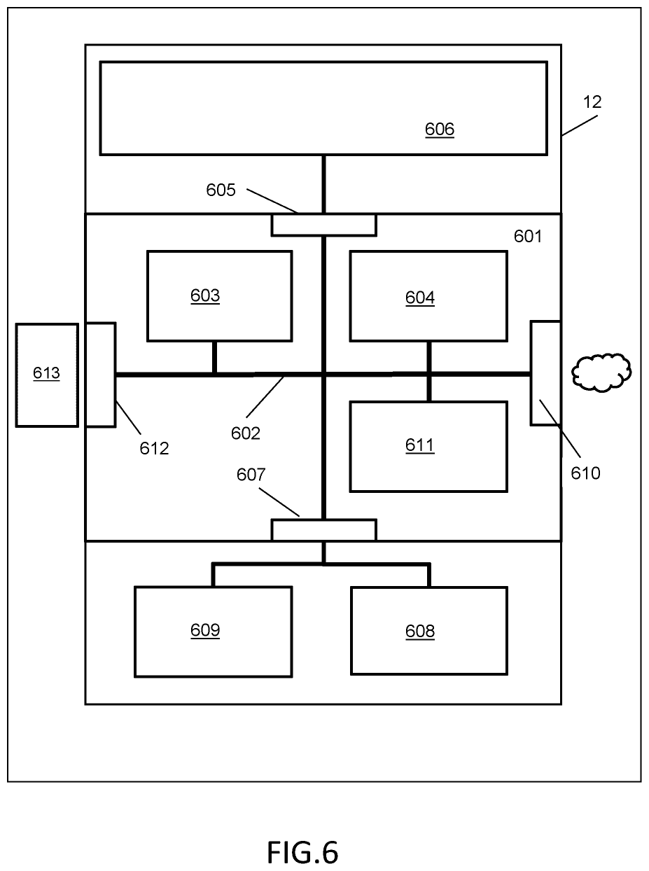

FIG. 6 depicts a high-level block diagram of an apparatus 600 suitable for implementing various aspects of the disclosure. Although illustrated in a single block, in other embodiments the apparatus 600 may also be implemented using parallel and distributed architectures. Thus, for example, various steps such as those illustrated in the system and methods described above by reference to FIG. 3 to 5 may be executed using apparatus 600 sequentially, in parallel, or in a different order based on particular implementations.

According to an exemplary embodiment, depicted in FIG. 6, apparatus 600 comprises a printed circuit board 601 on which a communication bus 602 connects a processor 603 (e.g., a central processing unit “CPU”), a random access memory 604, a storage medium 611, an interface 605 for connecting a display 606, a series of connectors 607 for connecting user interface devices or modules such as a mouse or trackpad 608 and a keyboard 609, a wireless network interface 610 and a wired network interface 612. Depending on the functionality required, the apparatus may implement only part of the above. Certain modules of FIG. 6 may be internal or connected externally, in which case they do not necessarily form integral part of the apparatus itself. E.g. display 606 may be a display that is connected to the apparatus only under specific circumstances, or the apparatus may be controlled through another device with a display, i.e. no specific display 606 and interface 605 are required for such an apparatus. Memory 611 contains software code which, when executed by processor 603, causes the apparatus 600 to perform the methods described herein. Storage medium 613 is a detachable device such as a USB stick which holds the software code which can be uploaded to memory 611.

The processor 603 may be any type of processor such as a general purpose central processing unit (“CPU”) or a dedicated microprocessor such as an embedded microcontroller or a digital signal processor (“DSP”).

When the apparatus 600 implements a first base station as described above, memory 604 is used to store the observations of the states S^{t} of the environment, the probabilities that a path is used for conveying the downlink data, the actions X^{t} determined based on the probabilities, the rewards Q^{t}ₚ associated with the actions, the experiences Y^{t} sent to the central entity and the current common neural network policy πₖ received from the central entity.

When apparatus 600 implements a central entity as described above, the memory 604 is used to store the experiences Y^{t} received from the reinforcement learning agents RLₘ and the current common neural network policy πₖ generated by the central entity.

In addition, apparatus 600 may also include other components typically found in computing systems, such as an operating system, queue managers, device drivers, or one or more network protocols that are stored in memory 611 and executed by the processor 603.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure as determined based upon the claims and any equivalents thereof.

For example, the data disclosed herein may be stored in various types of data structures which may be accessed and manipulated by a programmable processor (e.g., CPU or FPGA) that is implemented using software, hardware, or combination thereof.

It should be appreciated by those skilled in the art that any block diagrams herein represent conceptual views of illustrative circuitry embodying the principles of the disclosure. Similarly, it will be appreciated that any flow charts, flow diagrams, state transition diagrams, and the like represent various processes which may be substantially implemented by circuitry.

Each described function, engine, block, step can be implemented in hardware, software, firmware, middleware, microcode, or any suitable combination thereof. If implemented in software, the functions, engines, blocks of the block diagrams and/or flowchart illustrations can be implemented by computer program instructions/software code, which may be stored or transmitted over a computer-readable medium, or loaded onto a general purpose computer, special purpose computer or other programmable processing apparatus and/or system to produce a machine, such that the computer program instructions or software code which execute on the computer or other programmable processing apparatus, create the means for implementing the functions described herein.

In the present description, block denoted as “means configured to perform . . . ” (a certain function) shall be understood as functional blocks comprising circuitry that is adapted for performing or configured to perform a certain function. A means being configured to perform a certain function does, hence, not imply that such means necessarily is performing said function (at a given time instant). Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included. Their function may be carried out through the operation of program logic, through dedicated logic, through the interaction of program control and dedicated logic, or even manually, the particular technique being selectable by the implementer as more specifically understood from the context.

As used herein, the term “and/or,” includes any and all combinations of one or more of the associated listed items.

When an element is referred to as being “connected,” or “coupled,” to another element, it can be directly connected or coupled to the other element or intervening elements may be present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1. A first base station for use in a radio access network comprising at least one second base station, the first base station comprising:
at least one processor; and
at least one memory storing instructions that, when executed by the at least one processor, cause the first base station at least to perform:
splitting downlink data associated with a plurality of user devices between a first path through the first base station and at least one second path through the at least one second base station, the splitting comprising a plurality of reinforcement learning agents associated with the plurality of user devices, wherein the reinforcement learning agents are caused to perform at least:
applying a current common neural network policy to select a path amongst the first and the second paths based on observed performance metrics of the first and second paths and to generate a reward associated with the selected path;
sending tuples comprising the selected path, the performance metric associated with the selected path and the reward associated with the selected path, to a central entity in the radio access network;
receiving an updated common neural policy from the central entity; and
updating the current common neural network policy with the updated common neural network policy.

2. A device comprising a central entity for providing a common neural network policy to a first base station for splitting downlink data associated with a plurality of user devices between a first path through the first base station and at least one second path through at least one second base station in a radio access network, the central entity comprising:
at least one processor; and
at least one memory storing instructions that, when executed by the at least one processor, cause the central entity at least to perform:
receiving tuples from reinforcement learning agents in the first base station, the reinforcement learning agents being associated with the plurality of user devices, the reinforcement learning agents applying the current common neural network policy to select a path amongst the first and the second paths based on observed performance metrics of the first and second paths and to generate a reward associated with the selected path, a given tuple comprising a given selected path, a given performance metric associated with the given selected path and a given reward associated with the given selected path;
generating an updated common neural network policy by maximizing an expected cumulative reward for the received tuples; and
sending the updated common neural network policy to the reinforcement learning agents of the first base station.

3. The first base station as claimed in claim 1, wherein the common neural network policy is initialized with an initial policy.

4. The first base station claimed in claim 3, wherein the initial policy is generated offline, based on labelled data, and is optimized to select the path currently offering the best performance metric.

5. The first base station as claimed in claim 3, wherein all but at least one reinforcement learning agents comprise means for selecting the path currently offering the best performance metric, instead of applying the current common neural network policy sent by the central entity, during a training phase used to obtain the initial policy from the central entity.

6. A method for splitting downlink data associated with a plurality of user devices between a first path through a first base station and at least one second path through at least one second base station in a radio access network, the method comprising using a plurality of reinforcement learning agents associated with the plurality of user devices, the reinforcement learning agents:
applying a current common neural network policy to select a path amongst the first and second paths based on observed performance metrics of the first and second paths and to generate a reward associated with the selected path,
sending tuples comprising the selected path, the performance metric associated with the selected path and the reward associated with the selected path, to a central entity in the radio access network,
receiving an updated common neural policy from the central entity,
updating the current common neural network policy with the updated common neural network policy.

7. A method for providing a common neural network policy for splitting downlink data associated with a plurality of user devices between a first path through a first base station and at least one second path through at least one second base station in a radio access network, the method comprising
receiving tuples from reinforcement learning agents in the first base station, the reinforcement learning agents being associated with the plurality of user devices, the reinforcement learning agents applying the current common neural network policy to select a path amongst the first and second paths based on observed performance metrics of the first and second paths and to generate a reward associated with the selected path, a given tuple comprising a given selected path, a given performance metric associated with the given selected path and a given reward associated with the given selected path,
generating an updated common neural network policy by maximizing an expected cumulative reward for the received tuples,
sending the updated common neural network policy to the reinforcement learning agents of the first base station.

8. The method as claimed in claim 6, wherein the common neural network policy is initialized with an initial policy.

9. The method as claimed in claim 8, wherein the initial policy is generated offline, based on labelled data, and is optimized to select the path currently offering the best performance metric.

10. The method as claimed in claim 6, wherein the initial policy is obtained from the central entity as the result of a training phase during which at least one reinforcement learning agent applies the current common neural network policy sent by the central entity and the other reinforcement learning agents select the path currently offering the best performance metric instead of applying the current common neural network policy sent by the central entity.

11. The device as claimed in claim 2, wherein maximizing an expected cumulative reward for the received tuples is achieved by using a policy gradient method.

12. The device as claimed in claim 11 wherein the policy gradient method is a Proximal Policy Optimization algorithm.

13. The first base station as claimed in claim 1, wherein the performance metric is the amount of data in flight over the first and second paths.

14. A non-transitory computer-readable medium encoded with instructions which, when executed on an apparatus, cause the apparatus to carry out the method as claimed in claim 6.
